(19) United States
(12) Patent Application Publication
(10) Pub. No.: US 2010/0050530 A1
(43) Pub. Date: Mar. 4, 2010

(54) Sliding Door

(75) Inventor: Peter Blasi, Mahlberg (DE)

Correspondence Address: GUDRUN E. HUCKETT DRAUDT, SCHUBERTSTR. 15A, WUPPERTAL, 42289, DE

(73) Assignee: BLASI-GMBH AUTOMATISCHE TÜRANLAGEN, Mahlberg (DE)

(21) Appl. No.: 12/515,753

(22) PCT Filed: Nov. 14, 2007
(86) PCT No.: PCT/DE07/02049

§ 371 Date: May 21, 2009

(30) Foreign Application Priority Data
Nov. 22, 2006 (DE) 10 2006 054 927.9

(51) Int. Cl. E05F 15/14

(52) U.S. Cl. 49/358

(57) ABSTRACT

A sliding door has a sliding leaf comprising a peripheral frame. A top guide rail and a bottom guide rail are provided, wherein the sliding leaf is slidable in the top and bottom guide rails. A drive motor is arranged within the frame of the sliding leaf either in the vertical area of the frame or in the horizontal area of the frame.

The invention concerns a sliding door according to the preamble of claim 1.

In concrete, it concerns an automatic facade sliding door. They are known in many embodiments. The basic principle resides in that at the top and the bottom guide rails are provided along which the sliding leaf of the sliding door is moveable.

The electromotoric drive of the sliding leaf is realized in that either in the floor or on the ceiling a corresponding drive unit is arranged. The disadvantage resides in that this drive unit has a great height and thus, with respect to its vertical extension, requires a lot of space. Often it is then not possible to mount the sliding door in the corresponding building opening.

Based on this, the object of the invention is to provide a sliding door of the afore mentioned kind which as a whole does not have a great height.

The technical solution is characterized by the features in the characterizing portion of claim 1.

The principal idea of the sliding door according to the invention resides in that the drive motor is no longer arranged as in the past in the floor area or in the ceiling area but instead in the frame of the sliding leaf. This has the advantage that the drive motor is located within an area, i.e., in the frame of the sliding leaf, which is present anyway. This means however that the top and bottom guide rails can be constructed to be very flat because they must no longer accommodate the drive motor.

In this connection, according to the embodiment of claim 2 the drive motor can be arranged either in the vertical area or in the horizontal area of the frame. Both alternatives are available.

A further embodiment proposes according to claim 3 that the drive motor is arranged in the floor area or in the ceiling area of the sliding leaf. Preferred is the floor area.

A first variant with regard to the arrangement of the sliding leaf is proposed by claim 4. The basic principle resides in that the weight load is supported in the floor area while in the top area a guide is provided.

In this connection, in accordance with the embodiment of claim 5, as a top guide a vertical guide bolt can be provided. It is guided in an intermediate gap between two rail sections.

According to the embodiment of claim 6, as a lower support a spherical structure or a roll can be provided. This spherical structure can be a spherical segment. This spherical structure or the roll are arranged at the lower end of the shaft of the drive motor but do not rotate with it.

Alternatively, according to the embodiment of claim 7, the actual drive element of the drive motor can be provided as the lower support.

A second variant with regard to the arrangement of the sliding leaf proposes according to claim 8 the basic principle that the sliding leaf has at the top a carriage by means of which the sliding leaf can be movably supported on the top guide rail. This means that the weight load is carried in the ceiling area.

The embodiment according to claim 9 proposes a variant of a drive motor. In this variant, as a drive element a disk-shaped wheel of the drive motor is provided which rests on a rail section. Inasmuch as the drive motor is arranged in the vertical area of the frame, this disk-shaped wheel is preferably in the form of a flat cone that rests with its outer wall surface on the rail section. Upon rotation of this wheel a corresponding frictional connection with the rail section occurs and thus an advancing movement. Inasmuch as the drive motor is arranged in the horizontal frame area of the sliding leaf, the disk-shaped wheel rolls with its circumferential edge on the rail section.

Alternatively, according to the embodiment of claim 10, as a drive element a gear wheel of the drive motor can be provided which meshes with a toothed rack. This toothed rack defines the movement path of the sliding leaf in the guide rail.

In order to ensure a proper guiding action within the drive area, according to the embodiment of claim 11 in the area of the drive element a guide bolt is provided which is guided between two lateral rail sections. This guide bolt is preferably defined by the shaft of the drive motor.

In order to prevent that the sliding door is pushed open by wind or by force, a locking action between the sliding leaf and the outer door frame of the sliding door must be provided. This locking action can be realized by an appropriate rotary mechanism in the sense of conventional window levers. According to the invention, in accordance with the embodiment of claim 12 it is proposed that the actuation of the locking device is realized by means of a locking motor which is arranged within the frame of the sliding leaf.

Embodiments of the sliding door according to the invention will be explained in the following with the aid of the drawings. It is shown in:

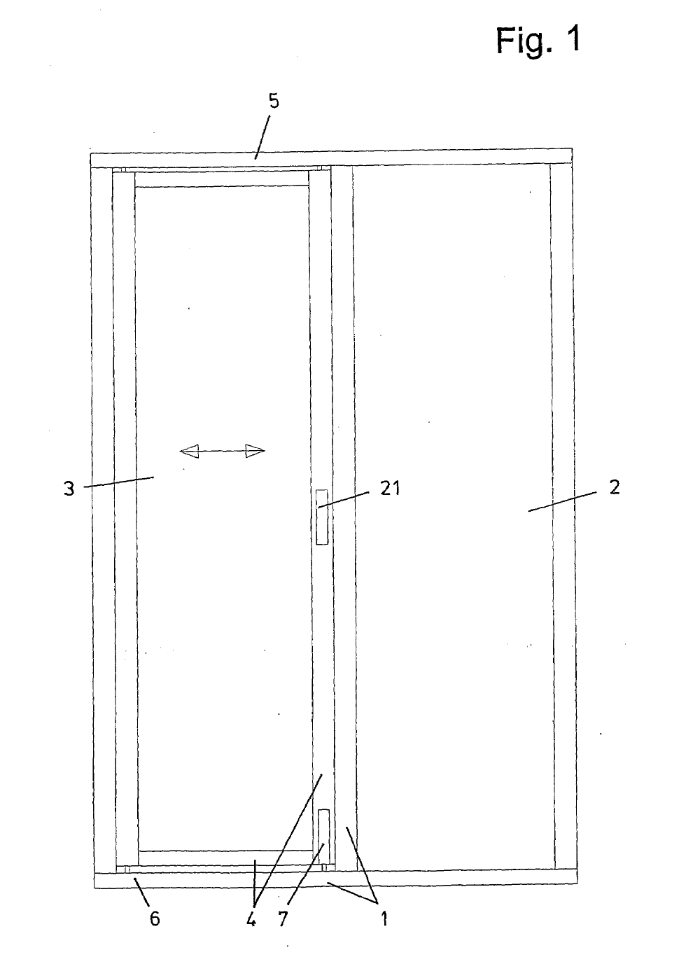

FIG. 1 a first embodiment of the sliding door with weight load carried in the floor area;

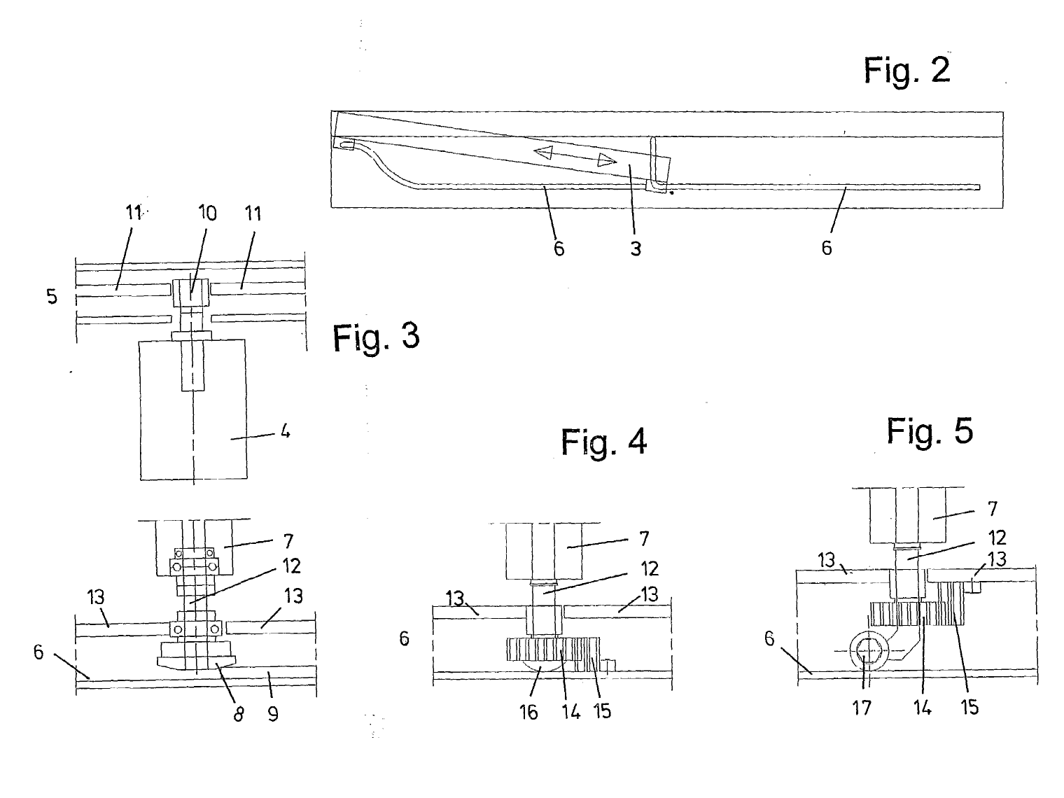

FIG. 2 a view of the bottom guide rail;

FIG. 3 a first variant of the drive device;

FIG. 4 a second variant of the drive device;

FIG. 5 a third variant of the drive device;

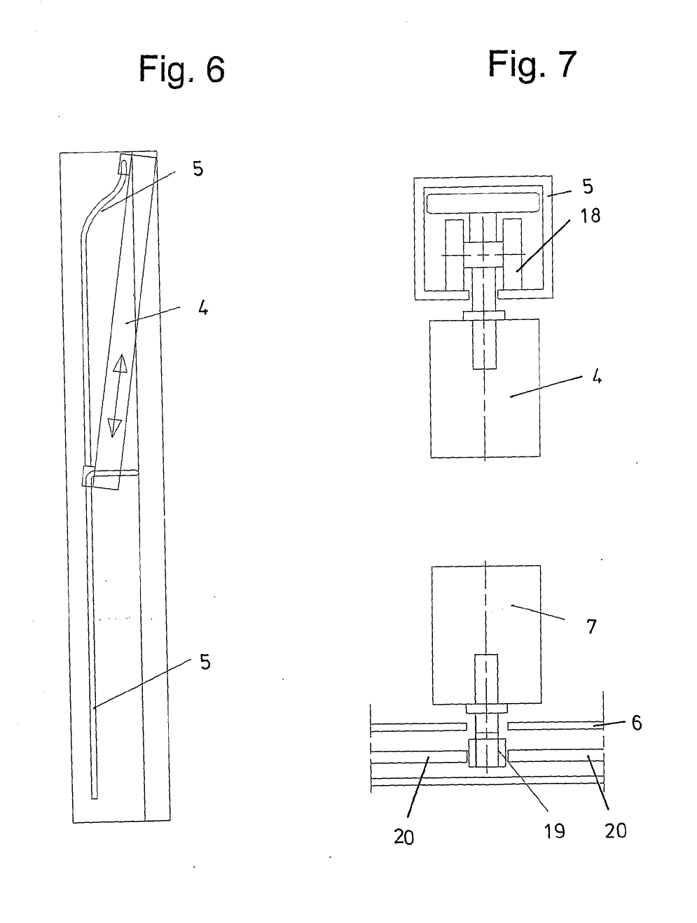

FIG. 6 a view of the top guide rail of a second embodiment with weight load carried in the ceiling area;

FIG. 7 a view of the drive device;

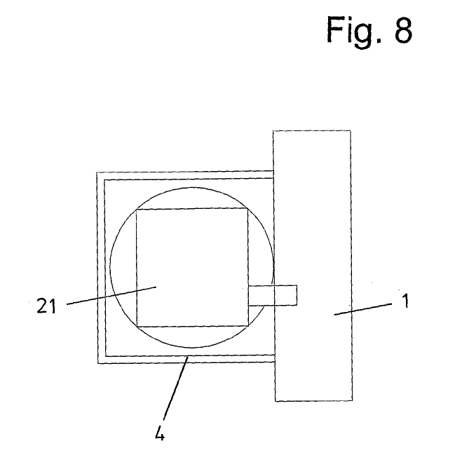

FIG. 8 a detail view in the area of the locking motor.

The automatic facade sliding door, as illustrated in FIG. 1, has a door frame 1 with a stationary leaf 2 and a movable sliding leaf 3.

The sliding leaf 3 has a peripherally extending frame 4. At the top a top guide rail 5 is assigned to the sliding leaf 3 and at the bottom a bottom guide rail 6. In these rails the two ends of the sliding leaf 3 are movably supported.

A drive motor 7 is provided for electromotoric actuation of the sliding leaf 3. The motor is arranged in the vertical frame 4 of the sliding leaf 3 in the bottom area.

In the embodiment of FIG. 3 the leading end of the drive shaft of the drive motor 7 has a disk-shaped wheel in cone shape. The bottom side of this disk-shaped wheel 8 rests on the edge of the rail section 9. By operating the drive motor 7, the disk-shaped wheel 8 will rotate and move on the rail section 9 so that as a whole the sliding leaf 3 is caused to move forward.

In order for the disk-shaped wheel of the drive motor 7 to be maintained exactly in its position, the shaft of drive motor 7 also has a guide bolt 10. The latter is arranged in the intermediate space between two opposed guide sections 11 and ensures centering.

The upper section of the sliding leaf 3 has at the ends a vertical guide bolt 12, respectively, that is secured in the intermediate area between two rail sections 13.

The alternative embodiment has a gear wheel 14 of the drive motor 7 as a drive. It meshes with a toothed rack 15 that extends along a movement path of the sliding leaf 3. The weight load is carried by a spherical structure 16.

The variant of FIG. 5 corresponds substantially to the variant of FIG. 4. Instead of the spherical structure 16 there is however a roll 17. It is located on the shaft of drive motor 7 but does not rotated with it.

A second embodiment is illustrated in FIGS. 6 and 7. Here the weight load of the sliding leaf 3 is carried in the ceiling area.

For this purpose, a carriage 18 with rollers is provided which is movable along the top guide rail 5. In the lower area there is a guide bolt 19 which is guided between two adjacent sliding sections 20. The drive action, not illustrated, by means of the drive motor 7 can be realized either in the bottom area or the ceiling area. In the bottom area, the drive is preferably realized by means of gear wheel and toothed rack, as illustrated in principle in FIGS. 4 and 5. However, the support elements for carrying the weight load are not present because the weight load is carried in the ceiling area.

FIG. 8 finally shows a locking motor 21 as illustrated in FIG. 1. This locking motor 21 locks the sliding leaf 3 relative to the doorframe 1 of the stationary leaf 2.

The electric power supply of the drive motor 7 as well as the locking motor 21 is realized by cables. The cables extend, on the one hand, in the frame 4 and, on the other hand, in the area of the top guide rail 5.

### LIST OF REFERENCE NUMERALS

1 door frame

2 stationary leaf

3 sliding leaf

4 frame

5 top guide rail

6 bottom guide rail

7 drive motor

8 disk-shaped wheel

9 rail section

10 guide bolt

11 rail section

12 guide bolt

13 rail section

14 gear wheel

15 toothed rack

16 spherical structure

17 roll

18 carriage

19 guide bolt

20 rail section

21 locking motor

What is claimed is:

1.-12. (canceled)

13. Sliding door comprising:
a sliding leaf comprising a peripheral frame;
a top guide rail and a bottom guide rail, wherein the sliding leaf is slidable in the top and bottom guide rails;
a drive motor arranged within the frame of the sliding leaf.

14. Sliding door according to claim 13, wherein the drive motor is arranged in the vertical area of the frame.

15. Sliding door according to claim 13, wherein the drive motor is arranged in the horizontal area of the frame.

16. Sliding door according to claim 13, wherein the drive motor is arranged in the bottom area of the sliding leaf.

17. Sliding door according to claim 13, wherein the drive motor is arranged in the ceiling area of the sliding leaf.

18. Sliding leaf according to claim 13, wherein the sliding leaf is guided in the top guide rail and is supported on the bottom guide rail.

19. Sliding door according to claim 18, comprising a top guide that is vertical guide bolt guided between two lateral rail sections of the top guide rail.

20. Sliding door according to claim 18, wherein the sliding leaf comprises a spherical structure or a roll as a lower support.

21. Sliding door according to claim 18, wherein the drive motor has a drive element provided as a lower support.

22. Sliding door according to claim 13, further comprising a carriage connected to the sliding leaf, wherein the sliding leaf is suspended by the carriage on the top guide rail and the sliding leaf is guided in the bottom guide rail.

23. Sliding door according to claim 13, wherein the drive motor has a drive element that is a disk-shaped wheel and wherein the disk-shaped wheel rests on a rail section.

24. Sliding door according to claim 23, wherein in the area of the drive element a guide bolt is provided and the guide bolt is guided between two lateral rail sections.

25. Sliding door according to claim 13, wherein the drive motor has a drive element that is a gear wheel, wherein the gear wheel meshes with a toothed rack.

26. Sliding door according to claim 23, wherein in the area of the drive element a guide bolt is provided and the guide bolt is guided between two lateral rail sections.

27. Sliding door according to claim 13, further comprising a locking motor arranged in the frame, wherein the locking motor locks the sliding leaf in an outer door frame of the sliding door.
